(19) United States
(12) Patent Application Publication
(10) Pub. No.: US 2014/0358983 A1
(43) Pub. Date: Dec. 4, 2014

(54) Dynamic Loading of Application Components

(71) Applicant: UNIVERSITE DE PAU ET DES PAYS DE L'ADOUR, Pau Cedex (FR)

(72) Inventors: Marc DALMAU, La Bastide Clairence (FR); Philippe ROOSE, Ustaritz (FR)

(21) Appl. No.: 14/289,385

(22) Filed: May 28, 2014

(30) Foreign Application Priority Data
May 29, 2013 (FR) 1354888

(51) Int. Cl. H04L 29/08

(52) U.S. Cl. CPC H04L 67/10
USPC 709/201

(57) ABSTRACT

A system supervises applications executing on a set of electronic devices linked by one or more networks. Each device comprises a local supervision entity, the supervision entities cooperating to control the applications, each application comprising a set of application components, and the supervision entity of a given device executes, in response to a command to receive an application component on a reception device, the component having a given starting state: communicating with a set of supervision entities to search for a code file comprising the executable code associated with the application component, loading the executable code file associated with the component on the reception device, in response to the availability of the code file on the reception device, starting the component in the starting state on the basis of the loaded code, by encapsulating it in a container controllable by the supervision entity.

### CROSS-REFERENCE TO RELATED APPLICATION

This application claims priority to foreign French patent application No. FR 1354888, filed on May 29, 2013, the disclosure of which is incorporated by reference in its entirety.

### FIELD OF THE INVENTION

The present invention generally relates to electronic devices and in particular to a process and a system for supervising application components for such devices.

### BACKGROUND

Recent technological advances over the last few years have placed the emphasis on the democratization of wireless networks and on the miniaturization of communication kit. Currently, there exists on the market a multitude of personal electronic devices that are ever more lightweight, compact, mobile and endowed with diverse means of wireless communication, such as portable telephones, intelligent mobile telephones (“smartphones”), tablets, laptop computers or else sensors. These devices concentrate complex and very diversified functionalities: telephony, instant messaging, Internet browsing, location system (GPS standing for “Global Positioning System”), audio player, etc.

These devices form the subject of a growing demand for ever richer and more customized services. The challenge is to be able to propose applications for these devices which adapt both to the wishes of the users and to the physical environment in which they operate.

Mobile electronic devices have the capability to be able to account not only for their hardware and software environment but also, with the arrival of peripherals such as wireless sensors or sensors integrated into portable telephones, to be able to measure physical quantities related to the environment of the device or to the device itself, such as temperature, pressure or else speed of movement. The integration of the data arising from such devices into the applications may make it possible to offer users services that are better adapted to their current situation. However, these devices possess characteristics (energy autonomy, mobility, limited resources) which necessitate the adaptation of the applications as well as of the services rendered by the latter to ensure correct operation for a sufficient duration, and service continuity in case of unavailability of a peripheral of the electronic device, for example when a peripheral of the electronic device no longer possesses sufficient battery. In the absence of service continuity, all the services offered by the peripheral then cease to operate, implying a break in service. This may result in limited comfort of use for the user, notably in the case where applications are currently executing.

Context-sensitive supervision systems are known which react to changes of context to provide the user with services adapted to the situation. Such systems can rely on various types of adaptations: adaptation of content, adaptation of presentation, adaptation of behaviour, structural adaptation, adaptation of deployment.

Thus, supervision systems exist for adapting the content of the applications which execute on electronic devices as a function of context, such as for example the solution described in Christoph Dorn, Richard N. Taylor—Co-adapting human collaborations and software architectures—ICSE 2012 Proceedings of the 2012 International Conference on Software Engineering—pp. 1277-1280. As a function of the situation, the data can be modified so that the user is presented only with those which are relevant to his situation.

Other known systems are configured to adapt the presentation in the field of MMIs (the acronym standing for Man Machine Interface). As a function of the hierarchical status of the user, the interface of the application will or will not present an information item and will or will not propose a functionality, such as for example the solution described in the article by Y. Gabillon, G. Calvary, H. Fiorino, entitled “Composition d'Interfaces Homme-Machine en contexte: approche par planification automatique” [Composition of Man-Machine Interfaces in context: approach by automatic planning], Revue TSI. Vol. 30, 2011.

In yet other systems, there is envisaged an adaptation of behaviour which relies on the adaptation of the functionalities provided by a component or a service as a function of the context, such as for example the solution described in the article by Peyman Oreizy, Nenad Medvidovic, Richard N. Taylor, entitled “Runtime Software Adaptation: Framework, Approaches, and Styles”, ICSE Companion '08 Companion of the 30th international conference on Software engineering, pp. 899-910. In yet other approaches, the supervision systems carry out a structural adaptation which is aimed at modifying the composition of the application and/or the connections between the various components with the aim of obtaining an application whose behaviour remains unchanged. This type of adaptation is more customarily used in the field of components-based distributed applications.

Supervision systems are also known which adapt the deployment as a function of the context, as proposed for example in the article by Ning Gui, Vincenzo de Florio, Hong Sun, Chris Blondia entitled “Toward architecture-based context-aware deployment and adaptation”, The Journal of Systems and Software 84 (2011) 185-197—Elsevier, 2011. Such systems implement deployments which take into account the properties of the peripherals supporting the application. This type of adaptation is often used to cope with the problems engendered by the hardware limitations of the mobile and constrained devices, used massively nowadays.

Existing solutions relying on adaptation of content, adaptation of presentation and adaptation of functionality are essentially directed towards the user. The content and the functionalities are adapted as a function of his preferences and the presentation is adapted as a function of his status for example. Adaptations of structure and of deployment are particularly appropriate for hardware constraints and for network constraints. However, the functionalities remain unchanged despite changes of context.

Solutions relying on structural adaptation and adaptation of deployment make it possible to adapt the functionalities as a function of context. An application is then represented by an assemblage of components that it is possible to modify by elementary operations such as addition, deletion of components as well as of connections between these components. These elementary operations act on the structure of the application.

Among the solutions based on structural adaptation as a function of context, the article by O. Riva, T. Nadeem, C. Borcea, L. Iftode, Context-Aware Migratory Services, in Ad Hoc Networks IEEE Transactions on Mobile Computing, Vol. 6, No. 12, December 2007, proposes a service model allowing adhoc networks to provide services capable of adapting to context so as to offer the client service continuity. A migration service supervises the services and reacts by triggering migrations of services whenever a node is no longer capable of supporting the execution of the service, causing the continuation of the service on another node. The migration aspect is rendered invisible to the client applications through the use of a single virtual terminal. Also known is an approach based on lightweight components for designing composite Web services, which is described in the article by V. Maurin, N. Dalmasso, B. Copigneaux, S. Lavirotte, G. Rey, J. Y. Tigli, Simply engine-wcomp: plate-forme de prototypage rapide pour l′informatique ambiante basée sur une approche orientée services pour dispositifs réels/virtuels [fast prototyping platform for ambient computing based on a services oriented approach for real/virtual devices], David Menga and Florence Sedes, editors, UbiMob, volume 394 of ACM International Conference Proceeding Series, pages 83-86. ACM, 2009. This solution makes it possible to construct applications in the form of Web services graphs based on the container concept. Moreover, it provides middleware based on the concept of Assemblage Aspects making it possible to adapt Web services. Such a solution allows the reuse of services and thereby extensibility and communication based on events, thus guaranteeing high system reactivity. Another advantage of this solution is that it allows the mobility of the applications (Web service paradigm) and affords flexibility at the level of the structure that it is possible to adapt (component paradigm).

The MUSIC project (R. Rouvoy, P. Barone, Y. Ding, F. Eliassen, S. Hallsteinsen, J. Lorenzo, A. Mamelli, and U. Scholz. MUSIC: Middleware Support for Self-Adaptation in Ubiquitous and Service-Oriented Environments—Book on Software Engineering for Self-Adaptive Systems (SEfSAS). LNCS 5525-2009) provides middleware allowing the reconfiguration of mobile context-sensitive applications. The adaptation process defined in MUSIC relies on the principles of planning based adaptation. Planning based adaptation refers to the capability for reconfiguration of an application in response to changes of context by exploiting awareness of its composition and of the Quality of Service metadata associated with each of its constituent services.

In the article by D. Ayed, C. Taconet, G. Bernard, and Y. Berbers. Cadecomp, Context-aware deployment of component-based applications, J. Network and Computer Applications, 31(3) 2008, middleware is proposed for the context sensitive deployment of components-based applications. This middleware extends the existing deployment services by integrating therewith the adaptation capabilities necessary in the field of mobile applications and constrained peripherals. It proposes a context-sensitive automatic deployment on the fly: an application is installed at the moment of its access and uninstalled just after the end of its use. The applications are considered to be a collection of components distributed over the network and linked together via ports. The deployment is defined according to five parameters: the architecture of the application, the placement of the instances of the components, the choice of their implementation, the properties of the components and their dependencies. This middleware relies on a data model making it possible to describe the context which acts on the deployment and to define deployment contracts which associate with each context situation all the possible variations of the deployment parameters. The context essentially models the characteristics of the instances of the components. This information is collected during specification and development by the producer of the component. It makes it possible to specify constraints on the placement of the components as well as on the connections, compulsory or optional.

The OSGi service platform (the acronym standing for “Open Services Gateway initiative”) implements a component model (designated by the term “Bundle”). They possess a life cycle allowing them to be stopped, started, updated and uninstalled warm. The service called “registry” makes it possible to register components (bundles) in the guise of services and to detect the appearance or the deletion thereof. OSGi is based on the discovery of services. However, the OSGi platform does not support the migration of components between peripherals and is based on the discovery of services.

The existing solutions thus propose various approaches to structural adaptation of applications (software framework, middleware, execution platform). However, none of the proposed approaches allows entirely dynamic and transparent decentralized supervision of the application components on a set of mobile devices, that could be of different kinds and connected by all types of networks, as a function of context. Moreover, none of the existing solutions proposes such a supervision system capable of dynamically loading the code of the application components during the creation or migration of an application component on an electronic device.

### SUMMARY OF THE INVENTION

The invention improves the situation by proposing a system for supervising applications executing on a set of electronic devices linked together by one or more networks. Each device comprises a local supervision entity, the supervision entities cooperating together to control the applications executing on the electronic devices, and each application comprises a set of application components. Advantageously, the supervision entity of a given device is able to execute the following steps, in response to a command to receive an application component on said device, termed the reception device, said component having a given starting state:

communicating with a set of supervision entities to search for a code file comprising the executable code associated with the application component,

loading the executable code file associated with the component on said reception device, in response to the availability of the code file on the reception device,

starting the component in said starting state on the basis of the loaded code, by encapsulating it in a container controllable by the supervision entity.

The reception command can be a command to create the component on the device, the starting state then being an initial state.

The reception command can be a command to migrate the component on the reception device from a source device, the starting state then being the state of the component in the source device.

According to a characteristic of the invention, the code file search can comprise the dispatching of a code request message by the supervision entity of the reception device to the supervision entities of said set of supervision entities, said message comprising information relating to the component and to the reception device.

The code request message can be relayed by each supervision entity receiving the message to another set of supervision entities, if the device hosting the receiving supervision entity does not hold the code file associated with the component.

In particular, the step consisting in relaying the code request message to another set of supervision entities can comprise the designation of the receiving supervision entity as relay for the dispatching of a response comprising the code file from another supervision entity to the reception device in the relayed message.

According to another characteristic of the invention, each supervision entity receiving the code request message is able to search for whether the device hosting the supervision entity holds a code file associated with the component on the basis of the name of the class of the component.

Each supervision entity receiving the code request message can determine whether the device hosting the receiving supervision entity holds a code file associated with the component by performing a search in a components code repository, on the basis of the information relating to the component and to the reception device, if the device hosting the receiving supervision entity manages a components code repository storing code files to components.

According to one embodiment of the invention, the supervision entity of the reception device is able to dispatch the code request message by broadcasting the message, if the device has a broadcasting-based dispatching capability, the set of supervision entities then comprising the supervision entities of the neighbour devices receiving said message dispatched by broadcasting.

According to another embodiment of the invention, the supervision entity of the reception device can maintain information relating to the supervision entities with which it communicates in a data structure while the supervision entity of the reception device is able to dispatch said code request message to supervision entities that are determined on the basis of said data structure.

As a variant, the supervision entity of the reception device can dispatch the code request message to a predefined proxy able to relay said message by broadcasting, the set of supervision entities comprising the supervision entities of the neighbour devices receiving said message dispatched by broadcasting by the proxy.

The proxy can be a supervision entity on a device having a public address on the Internet.

According to one aspect of the invention, each supervision entity can comprise a sender configured to transmit the requests for code associated with a component to a broadcasting-based dispatching client, the broadcasting-based dispatching client being configured to dispatch the messages of requests for code associated with a component to the set of supervision entities.

According to another aspect of the invention, the sender can be configured to transmit the code requests associated with a component to a client linked with the proxy.

The connection with the proxy can be kept open to allow the receipt of the responses relayed by the proxy in response to a code request.

The connection can be kept open by using the dispatching of messages of PING type.

Each supervision entity can furthermore comprise a response sender for dispatching the response of the supervision entity to a code request message to the supervision entity of the device which has relayed thereto the code request message originating from the reception device, the sender being configured to transmit the response to the supervision entity via at least one specific dispatching client according to the network available.

Each component can be associated with a given class of component, and in that the information relating to the component comprises the name of the class of the component.

The information relating to the component can comprise the type of device.

The local supervision entity of the reception device can load the code file by using a code loader associated with the code file.

The code loader associated with the code file on the device is created during the first creation of the component on the reception device.

The linkage between the component and its code loader is stored in the container of the component.

The invention furthermore proposes a process for supervising applications executing on a set of electronic devices connected together by one or more networks, each device comprising a local supervision entity. The supervision entities cooperating together to control the applications executing on the electronic devices. Each application comprises a set of application components. Advantageously, the process comprises the following steps, in response to a command to receive an application component on a device, termed the reception device, said component having a given starting state:

searching for a code file comprising the executable code associated with the application component on a set of devices;

loading the code file associated with the component on said reception device, in response to the availability of the code file on the reception device,

starting the component in said starting state on the basis of the loaded code, by encapsulating it in a locally controllable container.

The supervision system according to the invention thus makes it possible to load the code associated with an application component on a given device only when the device receives the component (creation or migration of a component on the device. A component can thus be migrated dynamically from device to device, whatever the type of electronic device (Android based intelligent telephone, personal computer, etc.), by restarting in the state it was in on the reception device. The dynamic loading of code is done in a very limited time, and is therefore transparent to the user.

The dynamic loading process according to the embodiments of the invention thus allows any device which receives a new component to obtain an up-to-date component. This mechanism makes it possible to limit the overloading of devices and notably the overloading of constrained devices (for example telephones), by providing components code repositories only on certain devices having sufficient resources to maintain such a repository and respond to the code requests originating from other supervision entities.

Moreover, the supervision system according to the invention is adapted for deploying only the necessary components while deleting the components which have become irrelevant. Indeed, by controlling each component which executes on the device independently of the other components (notably by means of the connectors of components created by the supervision entity), each supervision entity on a given device may at any moment be aware of the state of the components hosted on the device.

### BRIEF DESCRIPTION OF THE DRAWINGS

Other characteristics and advantages of the invention will become apparent on reading the detailed description which follows and the figures of the appended drawings in which:

FIG. 1 represents an exemplary architecture of the supervision system, according to an embodiment of the invention;

FIG. 2 represents an example of devices hosting components controlled by the supervision system, according to embodiments of the invention;

FIG. 3 shows the structure of the applications;

FIG. 4 is a diagram showing the structure of a component model, according to certain embodiments of the invention;

FIG. 5 illustrates the life cycle of a Component;

FIG. 6 schematically represents the structure of a component repository, according to certain embodiments of the invention;

FIG. 7 is a flowchart representing the steps implemented to load the code associated with a component from other supervision entities;

FIG. 8 is a flowchart illustrating the loading of a code file associated with a component on a device;

FIG. 9 is a flowchart representing the steps implemented to load the code associated with a component from other supervision entities, as a function of the available broadcasting capabilities;

FIG. 10 is a structural diagram of a local supervision entity illustrating the communication with the other supervision entities for the dynamic loading of code, according to certain embodiments of the invention; and

FIG. 11 is an exemplary diagram of the architecture of the kernel of each supervision entity.

### DETAILED DESCRIPTION

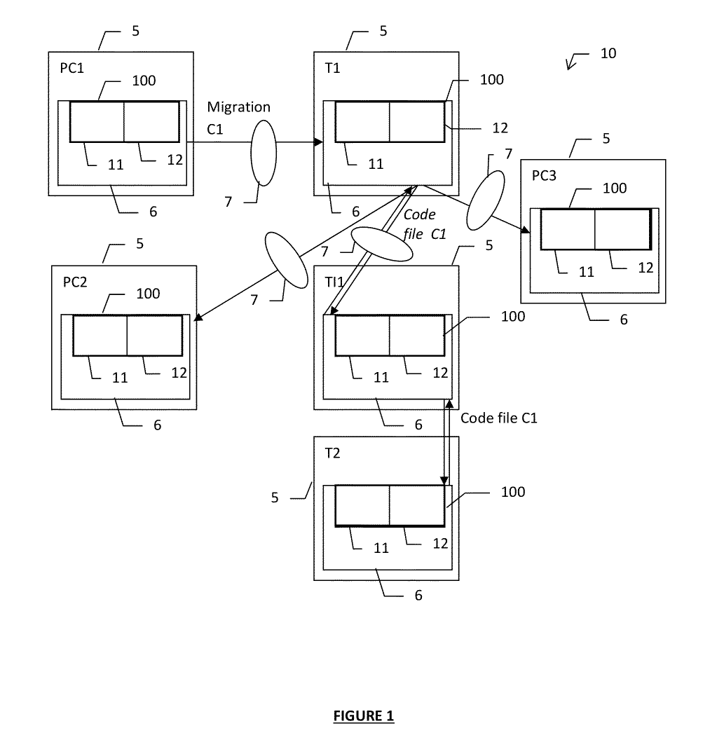

FIG. 1 represents a system for supervising applications 10 implementing the dynamic loading process according to the embodiments of the invention. The supervision system 10 represented is a dynamic and decentralized system for controlling the applications of a set of electronic devices 5 connected together by communication networks 7, for example of WIFI, or satellite type (GSM, 3G, 4G etc.). The electronic devices (also designated by the expressions “host devices” or “hosts” or “machines” in the subsequent description) can comprise any type of electronic device, notably mobile electronic devices, such as personal computers such as PC1 and PC2, intelligent mobile telephones (called “Smartphones”) such as T1 and T2, computer tablets such as TI1, etc. The communication networks supported by the electronic devices 5 can comprise several types of networks 7.

According to this decentralized approach, the supervision system 10 comprises a set of supervision entities 6 (also called “local supervision entities”), each hosted on a respective electronic device 5. The supervision entities cooperate together to dynamically supervise the application components which execute on the set of devices 5 as a function of context and of resources. These supervision entities dynamically control the life cycle of the components which can comprise the creation of a component on a device, the deletion of a component from a device 5 or the migration of an application component between a source device and a target device, notably to take account of the context of execution and the hardware resources. The local supervision entities 6 can furthermore be configured to collect information on the use of the hardware resources of the electronic devices, such as the battery, the memory or the CPU (the acronym standing for the expression “Central Processing Unit”), and/or the context of execution, represented for example by the network, the needs of the users, or the rules of use of the application, etc. The local supervision entities 6 can then dynamically trigger actions for reconfiguring the application components which execute on the electronic devices 5 in a user transparent manner according to a decentralized approach (no central server is required). Such reconfiguration allows the dynamic deployment and redeployment of applications and can notably involve the creation, the deletion or the migration of components. The components can thus be migrated from device to device, in an independent manner, whatever the type of the source device and of the reception device as a function of the context of execution and/or of the hardware resources, while pursuing their execution on each device which receives them (warm restarting).

The supervision system 10 according to the invention makes it possible notably to ensure service continuity in case of unavailability of an electronic device 5. In particular, in case of malfunction of a device, the supervision entities 6 can provide the application with everything it expects while future-proofing to the maximum its execution and while anticipating critical situations which may be related for example to the lifetime of a battery or the exceeding of the available bandwidth. The supervision system 10 makes it possible notably to distribute the load of the application over neighbouring electronic devices 5, and to optimize the distribution of the components of the application over the neighbouring electronic devices, when the device 5 on which the application executes is confronted with problems of resources, such as disconnections due to the discharging of the battery.

According to one aspect of the invention, the application part (comprising notably the code of the classes of the components and of the objects exchanged) is not resident on each of the supervised electronic devices 5 so as to limit the overload of the devices. Accordingly, the local supervision entity 6 on each device comprises a dynamic code loading function 100 for dynamically loading the code associated with an application component on a device 5 in response to a command to create or migrate this component on this device. The dynamic code loading function can furthermore be configured to delete the code associated with a component, when the component is no longer used on the device 5.

The dynamic loading of code according to the invention relies in particular on exchanges between a set of supervision entities distributed on electronic devices 5 that may be of different types, and on internal exchanges between the supervision entity of the device which receives a component and the component, by means of a component container created by the supervision entity.

To implement the dynamic code loading function 100, each local supervision entity 6, hosted on a given device, can comprise a code search unit 11 for searching for the executable code associated with a new component received on the electronic device (creation of a component or migration of a component on the device). The local supervision entity 6 furthermore uses a code loader 12 to load the code associated with the component when it has been found (possibly comprising notably the class and the software resources of the component, as well as the data exchanged by the component). The code loader 12 used to load the code associated with a component can be specific to the component or to the class of the component, and to the device. For example, when a component C1 is migrated from the device PC1 to the intelligent telephone of type 1, the supervision entity on the device T1 dispatches a code request message to the supervision entities of the other devices PC3, PC2, T2, TI1 so as to obtain the executable code associated with the component C1 (which may be the code associated with the class of the component). When the code file is found by one of the entities, here T2, it is forwarded to T1 which loads it dynamically. The person skilled in the art will understand that the representation of FIG. 1 is schematic and does not show the detailed structure of the supervision entities 6 and of their communication elements which will be described in greater detail hereinafter.

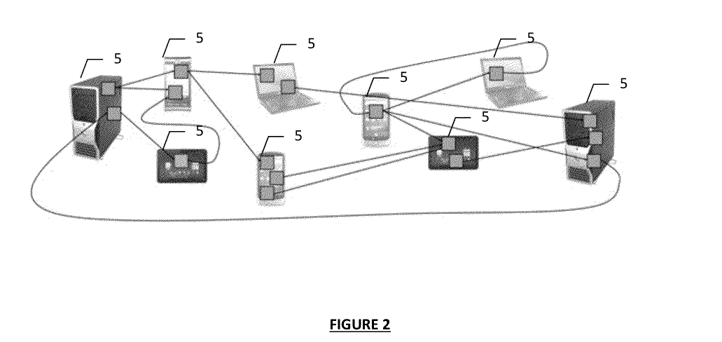

FIG. 2 shows examples of devices 5, of different types, executing applications controlled by the supervision system (not represented in the figure) according to the invention. An application can be composed of one or more services and each service can be carried out by one or more assemblages of components (represented by the hatched squares) connected by connectors (represented by the arrowed lines). The state of an application thus consists of the set of states of the components, devices, connectors between the components and of the environment. The supervision entities are configured to gather such data so as to process them and to trigger the appropriate reconfiguration actions. In response to these reconfiguration commands, the supervision entities can cooperate with one another to modify the general architecture of the application (possibly involving a modification of the distribution of the components over the set of devices involved in the application), by migrating some components (hatched squares) from one device 5 to another according to a migration process, and/or by replacing one or more components with others.

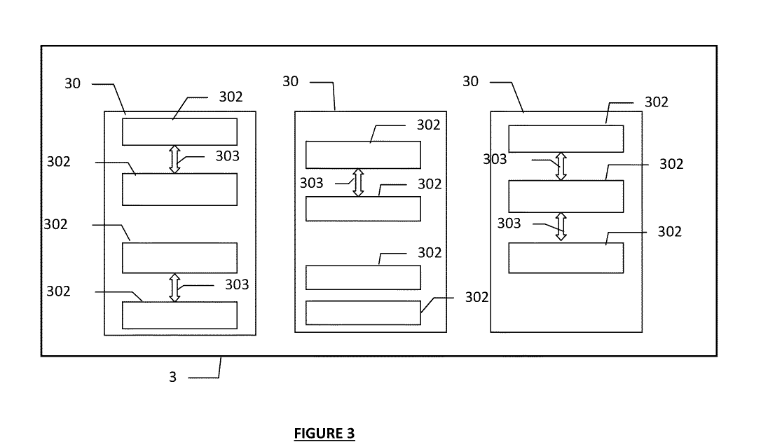

FIG. 3 represents the general structure of applications 3 controlled by the supervision system 10. Modular applications 3 based on distributed software components can be executed on the devices 5. The resulting modularity makes it possible to propose warm-reconfigurable, ad hoc solutions which guarantee the continuity of the applications and their future-proofing.

Each application 3 according to the invention comprises a set of interconnected functionalities 30. Each functionality itself consists of a set of software components 302 connected by connectors 303. These functionalities 30 can be carried out in various ways on the basis of assemblages of different components 302. The supervision system 10 therefore utilizes several functional decompositions corresponding to the diverse configurations of the architecture.

In order to be able to adapt dynamically, each application 3 has a reflexivity capability which allows it to have awareness of itself. This reflexivity capability may allow it to replace a service which is defective or ill-adapted to the current context with another service.

For this purpose, the supervision system 10 is configured to acquire awareness of the application in progress as well as the context of the application in a dynamic and transparent manner.

The supervision system 10 can be used for example to supervise an application for taking notes destined for the gardeners of a botanical park each equipped with devices 5, so as to allow them to monitor the plants and their progress (taking of pictures, taking of notes, location, etc.). The application can be hosted on intelligent telephones 5 (smartphones) allowing the gardeners to take geolocated notes, written or verbal. Each plant is accompanied by a bar-code identifier panel of QR code type (the acronym standing for the expression “Quick Response”), the reading of these QR codes facilitating the designation of the plants in the notes. For practical reasons (position of the note taker with respect to the panel), the reading of the QR codes can be delegated to another gardener. It is also possible to allow another gardener to complete a note taking.

When a gardener arrives in the park and has an intelligent telephone hosting a currently executing local supervision entity 6, an MMI (Man Machine Interface) component can be deployed thereto, offering 3 buttons: Edit/Select a note, record a voice note, activate geolocation.

If he selects the first button, a component C1 for choosing a written or verbal note is deployed allowing him to select an already present note while a component C2 for accessing the database of notes is deployed on the central server of the park. These two components C1 and C2 are connected together by connectors. If the gardener chooses a written note, an edit component C3 is deployed. When he wishes to introduce a QR code reading (scan) into his note, he is prompted with the list of devices of the other gardeners present in the park. He can then choose to scan the note himself or to delegate this task to one of his colleagues. In the latter case, an alert component (vibrator and message) C4 is deployed on this colleague's terminal so as to warn him of the request. If the colleague accepts, this alert component C4 is replaced with a QR code reading component C5 which is connected by connector to the first gardener's note taking component C6. As soon as the code has been read and the result inserted into the note, the reading (scan) component and the connector are automatically deleted.

If the gardener has turned geolocation on, when he saves his note on the server of the park, it will be able to be geolocated automatically. During a subsequent consultation of this note, this geolocation as well as the date will be accessible.

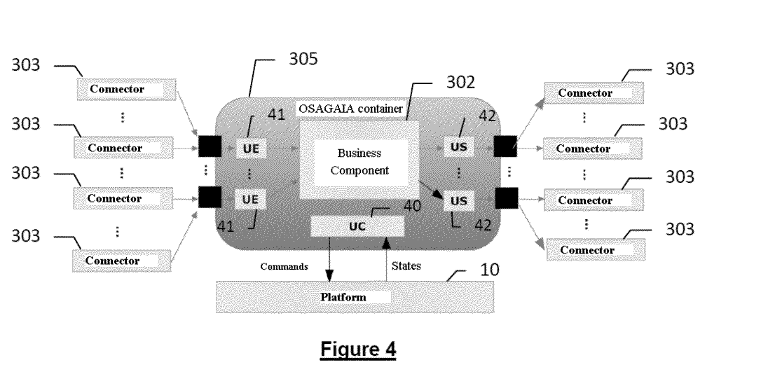

FIG. 4 illustrates the interactions between the components 302 and connectors 303 according to the invention. The supervision system 10 forms a supervision platform which is distributed over the devices 5 so as to be aware of the components 302 and connectors 303 deployed. It is furthermore configured to recover the context information that the latter may transmit to it. As a function of this information, the supervision system 10 determines whether reconfigurations must be implemented, involving component dynamic deployment and redeployment.

The supervision entities 6 use containers 305 to monitor the operation of the components 302 and the flow of the data streams between the components 302 connected by the connectors 303, on the associated device. The containers 305 are configured to gather the information between the entities 302 and 303. They furthermore make it possible to manage the hardware and software heterogeneity of the devices 5 as well as the mobility of the devices.

FIG. 4 shows more precisely a model of container 305 for a component 302 of Business Component type. In the subsequent description, the terms “business components”, “application components”, “software components”, or simply “components” may be used in a similar manner to designate a component. According to this model of container 305, the business logic contained in a business component is separated from the supervision managed by a container. The Component 302 can receive several data streams as input and produce several data streams as output. Moreover, each output stream can be duplicated. The container 305 represented encapsulates a single component 302 and can implement a set of non-functional properties, such as life cycle management, quality of service information recovery and communications management. The container 305 associated with a component on a device is created by the supervision entity 6 which receives the component, while the code of the component is loaded dynamically.

The container 305 possesses three unit types:
One or more input units (UE) designated by the reference 41 for receiving the data streams at input,
One or more output units (US) designated by the reference 42 for receiving the data streams at output, and
A Control unit (UC) designated by the reference 40.

The input units UE 41 and the output units US 42 can be connected to one or to several connectors 303. These units 41 and 42 allow the Component 302 to read and to write data originating from other components 302 or destined for other components 302. The component 302 can thus read data via the input units 41, perform its processing and write the results to the output units 42. The supervision entity 6 of the device hosting the component can use the control unit 40 (UC) to supervise the container 305. Accordingly, each component container 305 can register its control unit 40 as a service allowing the local supervision entity to control the various phases of the life cycle of a component 302.

The control unit 40 controls the elements of the component container 305. For example, the behaviour of the component can be controlled by the control unit 40 by means of a component initialization method (called init( )), of a component deletion method (called “destroy”) or else of a component activation method (called “Run_BC”). The input and output units 40 and 41 control the flow of the data in the container 305 and give the component access to its input and output streams.

The main functionality of a connector 303 is to link two components 302 together and to make the information flow between them. In the same manner as a component 302, a connector 303 constitutes an element of first class in that it can be created and destroyed dynamically. The connectors 303 are not limited to the implementation of one or more specific modes of communication (for example of Client/Server, Pipe & Filter type, etc.). Moreover, a connector 303 can act on the information exchanged between two components so as to adapt (technically or semantically) the data. Accordingly, each connector 303 may itself comprise a component. Moreover, the connectors 303 may themselves be encapsulated in containers.

In a preferred embodiment of the invention, each component comprises several classes (class of the component, classes of the data exchanged) and can include resources and libraries which are loaded dynamically during the creation of the first instance of the component on the device.

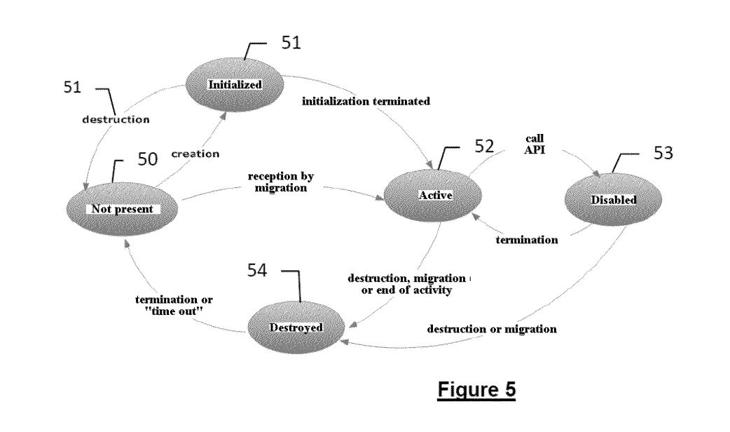

FIG. 5 illustrates the life cycle of a component 302. The components associated with a given application are initially written by the designer of the application. The supervision entity 6 of the device receiving a component encapsulates the component 302 in a container 305 which will control the life cycle thereof. The life cycle of a component can correspond to the calling of overloaded methods. This life cycle of a component is generally similar to that of an “applet” (term designating a piece of software which executes in the window of a Web browser), of a MIDIet (the acronym standing for “Mobile Information Device applet” and designating a program installed in a mobile information device) or of an activity of the Android operating system.

The life cycle of a component 302 corresponds to the three types of actions implemented by the supervision entities 6: the creation of a component on a host machine, the deletion of a component on a host machine and the migration of a component between two host machines connected in a network.

The creation of a component 302 comprises the instantiation of an object of the associated class (comprising the loading of executable code associated with the component), the encapsulation of this object in a container 305 and then the connection of its input and output streams.

The deleting of a component 302 comprises the stopping of the encapsulated component and then the deleting of its container 305 on the device. The code file associated with the component can then be deleted if the device no longer contains any component of the same class as the component. Its input/output streams can remain on standby awaiting a new component or awaiting deletion in their turn.

The migration of a component is implemented when a component 302 executing on a host A must be migrated to a host B. The supervision entity 6 hosted on the host A then stops the component at the level of the host A as during a deletion, and then dispatches the component to the supervision entity on the host B by using a mechanism for serializing the properties of the component, if the device B does not have the code associated with the component. The supervision entity 6 thereafter diverts the set of connectors 303 connected to this component 302 to their new destinations consisting of the host B. The component 502 received at B is encapsulated in a container 305 and then the supervision entity 6 reconnects the input and output streams of the component.

When a component 302 is created, it passes from the “non-present” state, designated by the reference 60, to the “Initialized” state, designated by the reference 61, where it executes an initialization method called “Init”. It thereafter passes to the “Active” state, designated by the reference 62, where it executes an execution method called “run_BC”. A component can also pass directly from the “non-present” state (60) to the “active” state (61) when it is received on the electronic device 5 subsequent to a migration. In this case the component is warm started in the same state as it was in previously on the source device from which it was migrated, so that no initialization phase is required. During calls of functions of the programming interface API (the acronym standing for the expression “Application Programming Interface”), comprising for example functions such as read, write, services of the supervision system, the component can be placed in a “Disabled” state, designated by the reference 63. From the Active state 62 and the Disabled state 63, the component 302 can be stopped and placed in the “Destroyed” state (state 64) where it executes a method called “Destroy”. A component 302 can pass from the active state 62 to the destroyed state 64 if it is at the end of the activity or has been migrated to another device. A component can notably pass from the “disabled” state 63 to the “destroyed” state 64 on a given device 5, during a migration to another electronic device 5. The transitions between the states 50 to 54 are caused by exceptions. An exception designates an interruption of the execution of a program in response to a specific event that may entail a change of state.

According to a characteristic of the invention, two exception classes can be used:
A first class called “StopBCException” which represents an exception which can be used to cause changes of state during reading or writing attempts or during access to the services of the supervision system (passage from the active state 62 to the disabled state 63).
A second class called “InterruptedException” which can be used to cause changes of state when a component 302 is in the disabled state 63 on a semaphore or is suspended.

After the execution of the “Destroy” method (in the “destroyed” state 64) or after a predefined time span, if the execution of the “Destroy” method does not terminate, the component 302 can be destroyed or migrated. During a migration of the component 302, its properties are serialized and on the new receiver electronic device 5, it is placed directly in the Active state 52.

According to a characteristic of the invention, the classes of a component 302 are loaded dynamically during the creation of the first instance of the component 302 on a device or during the receipt of the first instance of the component migrated on a device and may be dynamically deleted during the deletion of the last instance of the component on this device (transitions 50-51 and 50-52).

More precisely, the code of the components 302 is loaded dynamically in response to the creation or to the migration of a component on a device if it does not hold the code associated with the component. The supervision entity 6 on the device which receives the new component (requesting device or reception device) is configured to cooperate with a set of supervision entities 6 on other devices 5, that may be of different types from that of the requesting device, so as to search for the code associated with the component and to relay it to the requesting device, when the executable code of the component is not resident on this device. In particular, a device can hold the code associated with a component, either because it hosts a component of the sought-after class of the component, or because it manages a component repository, and this may be the case for certain unconstrained hosts (constrained devices have more limited resources, such as for example mobile telephones). The supervision entity 6 on the requesting device can be configured to wait for a response to the code request message for a parametrizable period, at the end of which the requested code may be considered to be not existent.

In the preferred embodiments of the invention, the component code exchanged between the devices 5 for the loading of code of this component onto a device can take the form of a code file. In particular, for devices 5 having an operating system of JAVA type, the component code file is a Java binary code file called a JAR file (file interpretable by the operating system). The subsequent description will be given with reference to a code file of JAR type.

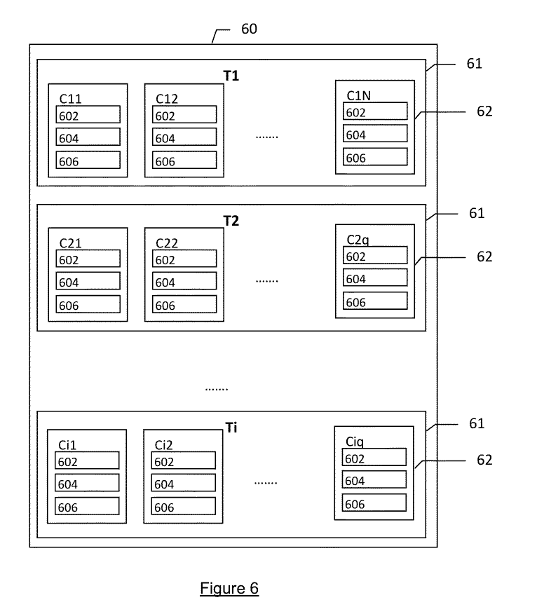

FIG. 6 represents an exemplary repository of components 60 which is placed on an unconstrained device (for example, personal computers PCs).

A code repository 60 can store, for each type of device, the code files associated with the components. The code repository can be partial, in the sense that it does not contain all the codes of components used by the devices, but only the code of certain components (for example, the components that are used most). Moreover, to optimize the performance of certain devices having lower processing capabilities, termed constrained devices, (for example, constrained device of telephone type), only certain unconstrained devices 5 can be associated with a complete or partial code repository. This makes it possible to limit the overload of certain devices (notably the unconstrained devices), linked with the maintaining of the code repository and with the dispatching of code in response to the requests of the supervision entities.

According to another aspect of the invention, the code repositories can be modified by the designer of the components. The component designer can thus add, at any moment, new components on one or more repositories. The management of the code repositories can be controlled in various ways. For example, an enterprise developing components can host code repositories on its own machines, if appropriate while limiting access to these repositories (for example through a subscription system), or deposit them on freely accessible machines.

When a device 5 manages a code repository, the code repository 60 can be stored on a memory area of the device, for example on a disc or on removable memory storage card SD (the acronym standing for “Secure Digital”) for devices of computer tablet or telephone type.

A code repository 60 can be structured into sub-repositories 61 corresponding to the various types of existing hosts T1, T2, Ti, etc. (for example PC, Android, etc.). Certain types of device can use such a repository of components 60, such as for example the devices of PC type, while others are not configured to manage such a repository. In the component repository 61, each component is represented by its code file Ci1, Ci2, Cin, etc.

According to one aspect of the invention, each code file associated with a component Ci1, Ci2, Cin, etc. may comprise the following information:

The binary code 602 (“byte code”) of each class necessary for the operation of this component 302 (including libraries) and classes of the objects exchanged between components;

The resources 604 used by the component (for example, images, files, etc.);

The name of the class of the component 606 which can be included for example in a file of “manifest” type. The name of the class 606 can be used by the local supervision entity 6 of the device maintaining the code repository 60 to retrieve a code file associated with a component (if the device is the reception device or if it receives the request from the supervision entity of another device).

Thus, when the local supervision entity 6 of a device verifies whether it holds the code of a component, either because the component has just been created or migrated on this device, or because it has received the request therefor from the supervision entity of another requesting device, it can use the class name of the component (if the component is received locally by the device) or the name of the class and the type of requesting device, if the request comes from another requesting device (this information will then be included in the message).

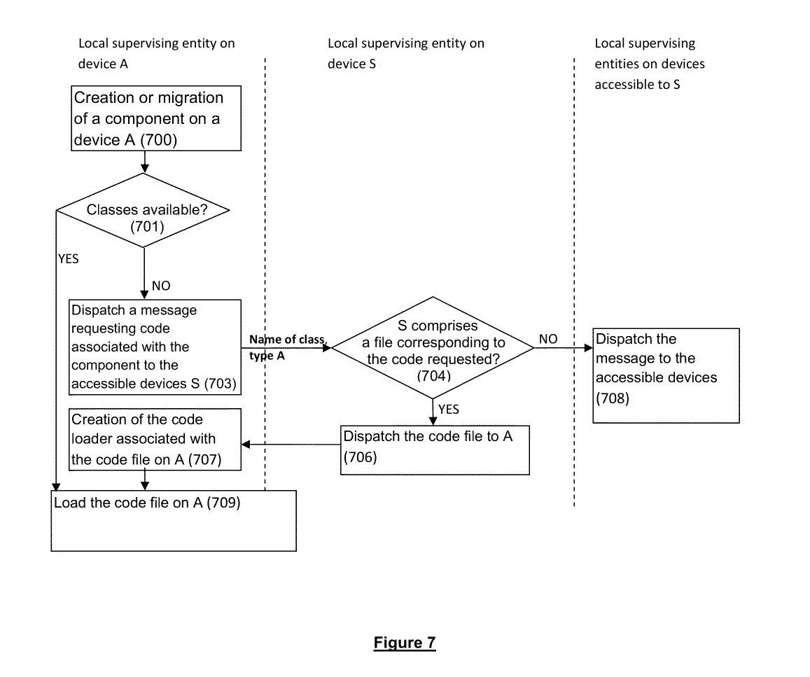

FIG. 7 is a flowchart representing the main steps implemented for the search for code associated with a component created or migrated on a device A, when the code file is not resident on the device, according to the embodiments of the invention.

The creation of a component on the electronic device A can be triggered dynamically as a function of the context and/or of the state of the resources. In this case, the component 302 will be started on the reception device from an initial state.

In the case where the component 302 is migrated to the electronic device A from another source device, the component 302 is serialized and encapsulated in a class of the supervision system by the local entity 6 on the source device before the migration. The serialization comprises the coding of the state of the properties of the component so as to allow its warm restarting on the device A. The serialized properties are thereafter encapsulated in a container of the supervision entity 6 of the source device. The reading of the properties by the supervision entity on the device A can be done only if the device A has the code of the classes of these properties so as to be able to de-encapsulate the properties of the components and assign them to the component.

Thus, when the device A receives the component 302, its properties have been serialized. However, the device A which receives a component must also have the class of the component 302 (binary code in JAVA) so as to be able to start the component in the same state (warm restarting).

In response to a command to create a new component or to migrate a component (700) on a device A (component migrated from a source device), the supervision entity on the device A determines whether the code file associated with the component (corresponding to the class of the component) is available on the device (701). If it is available, the supervision entity on the device A loads the classes of the component (709).

Otherwise, the local supervision entity 6 placed on the host A where the component is created (creation ab initio or subsequent to a migration) dispatches a code request message to a set of supervision entities on other devices in step 703. The message comprises information relating to the component and can comprise notably the name of the class of component 302 sought as well as the type of the electronic device A (for example Android-based device, personal computer PC). The devices to which the code request message is dispatched may be of any type, and in particular may be different from the type of the requesting device.

The broadcasting of the message to the supervision entity set in step 703 can be carried out in various ways, directly or indirectly, according to the possibilities associated with the networks on which the device A depends, for example by broadcasting, multi-casting or point-to-point broadcasting.

If the local entity 6 of a device S which receives such a code search request message (704) has the component class sought (704), it dispatches to the local entity 6 of the source device A the code file containing this component class (for example, JAR file in JAVA), in step 706. Such a situation may occur notably when the local entity 6 of the device S manages a repository of components 60 or as a variant when the device S is of the same type as the device A receives a component 302 of the same class as the class sought. The name of the class 606, contained in the code files 61, and the type of device specified in the code request message allows the local supervision entity 6 to determine whether they contain the requested class.

Otherwise, if the local entity 6 of the device S does not possess the code file associated with the class of the component sought, it rebroadcasts in the same manner as the device A (step 703) the code request message to a set of supervision entities as a function of the types of networks which it is able to access, in step 708, directly or indirectly according to the broadcasting capabilities (broadcast or multicast or other). In certain embodiments of the invention, the supervision entity 6 of the device S can also indicate in the message relayed that their responses must pass back through the device S which will transmit them to the device A (designating itself as possible relay). The devices which receive the message relayed in step 708 and which possess the class sought, for example because they manage a repository of components classes 60 or else because they possess an instance of the class of the component, will then respond to the device S which will therefore be able to play the role of relay in respect of the dispatching of the code file to the requesting device. Otherwise, they broadcast the message in the same manner (step 708) to the supervision entities which are accessible to them. In one embodiment of the invention, the messages are relayed only once, so that the response returns to the requesting device A either directly, or via one or more relays.

In response to the receipt of the code file corresponding to the class of component sought (“.jar” file) from one of the supervision entities which has received the code request message, the supervision entity of the requesting device loads the component code file onto the requesting device so as to allow the initialization of the component, if a direct creation is involved, or the warm restarting of the component, if the component has been migrated from a source device. In the case where the component has been migrated from a source device on the device A, the requesting device A which receives the file associated with the class of the component creates an instance of the component by de-encapsulation and de-serialization of its properties and warm starts it. The local supervision entity of the requesting device can then dispatch commands to the supervision entities 6 hosted on other devices 5 to ensure the redirection of the connectors 303 linked with the migrated component 302.

To load the code file received from another supervision entity, the local supervision entity 6 of the device A can create a code loader 11 (also called a class loader) associated with the code file in step 707, and then use the code loader to load the classes of the components and data exchanged by the component on the basis of the code file in step 709.

To optimize the memory occupancy, the code file corresponding to the class sought (jar file) will be able to be deleted on the device A, as soon as the last instance of the component 302 which uses it is deleted.

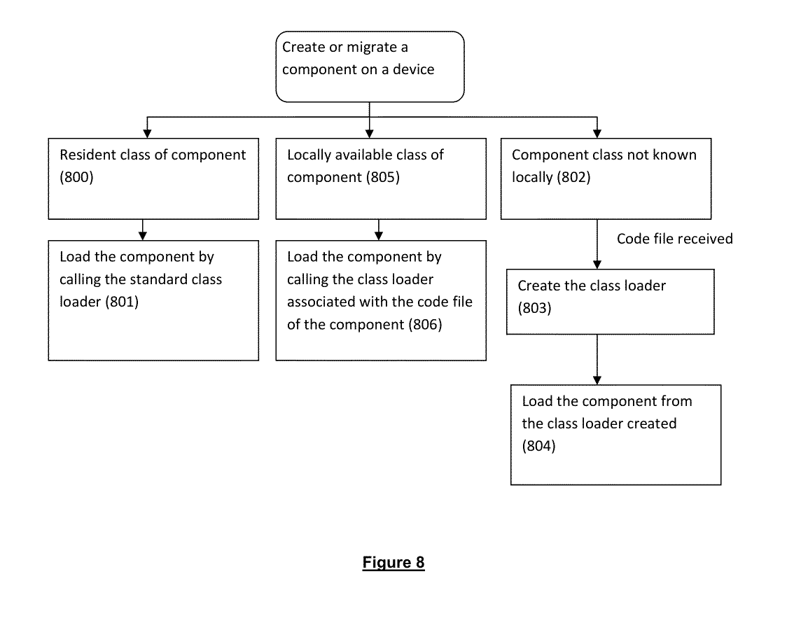

FIG. 8 is a flowchart illustrating the dynamic loading of the component classes (step 709 of FIG. 7) on the electronic device A, according to various cases.

The supervision entity resident on each device may possess a certain number of classes usable by all the components 302 (resident classes). Thus, if the class of the component is resident on the device (800), such as for example a Java standard class or a class included in the local supervision entity 6, in step 801 the call is transmitted to the java standard class loader. The standard loader of the JAVA virtual machine allows the dynamic loading of code by way of specializations of the class of the loader.

If the class of the component was not known (802) and was loaded in step 707 of FIG. 7 by the process for the dynamic loading of code, a code loader (also called a class loader) associated with the file is created by the local supervision entity 6 and registered (steps 707 of FIG. 7) in step 803. It is thereafter used to load the code (804). The class loader associated with each file is stored on the device A where it is created. The role of this class file is to load into the memory of the machine the code corresponding to a requested class (by searching through the file with which it is associated for the code part corresponding to the requested class). With each component 302 hosted on a device is thus associated the class loader which served to create it on this device in such a way that the future creations of objects arising from this component (for example when the component creates an object that it wishes to dispatch through an output connector) can thereafter be done through this same class loader. In devices dependent on the JAVA operating system, the creation of the class loader can comprise the definition of a specific class (called a Classloader) for loading code into the java virtual machine and the instantiation of an object thereafter associated with the component CM. In the particular case where the electronic device A uses an operating system of Android type, the class loader can furthermore inherit another type of code loading class called “DexClassLoader” since the binary code and the way of loading the code on devices of Android type are different.

According to a characteristic of the invention, the linkage between the component 302 and its class loader can be stored in the container 305 of the component 302 (in the form of an object which can be added to the properties of the container). This association between a component 302 and a class loader allows access by a component 302 to the resources included in the code file associated with the component (Jar file) by means of methods of accessing the resources called “getResourceAsStream” (to receive the data in stream form) and “getResourceAsByteArray” (to receive the data in binary data form). These methods belong to the class of the component model from which it inherits, called BCModel.

The class loader for a device of personal computer (PC) type differs from that used for a device using the Android operating system because of the different mode of loading of classes between these two types of devices.

If the class of the component 302 is included in a locally available file (805), the local supervision entity 6 transmits the call to the class loader 11 associated with this file in step 806 (case where the condition 701 is satisfied). Such a situation occurs for example, if the device A manages a code repository or possesses a component of the same class as the new component. Such a class loader has been created during the initial reception of the code file associated with the component by the device (in accordance with steps 802 and 803) for the creation of the first instance of the component. The class loader 11 associated with the code file is then used to load the class of the component as well as the classes of the objects at input and output of the component. The component code dynamic loading implemented by the supervision system thus makes it possible to dynamically add functionalities without relaunching the application and to replace certain components by others contextually better adapted so as to provide an optimal quality of service. Moreover, the components deployed for the needs of an application can be deleted in a transparent manner as soon as they are no longer used, so as to limit the overloading of the devices.

By controlling the life cycle of the components, each supervision entity has, at each instant, an awareness of the state of the components, thereby allowing it to detect whether a component is no longer used on its device, and to delete the code associated with the component.

A code request message can be dispatched in various ways to a set of supervision entities on other devices (step 704 of FIG. 7), according to the capabilities associated with the communication networks on which the requesting device A depends.

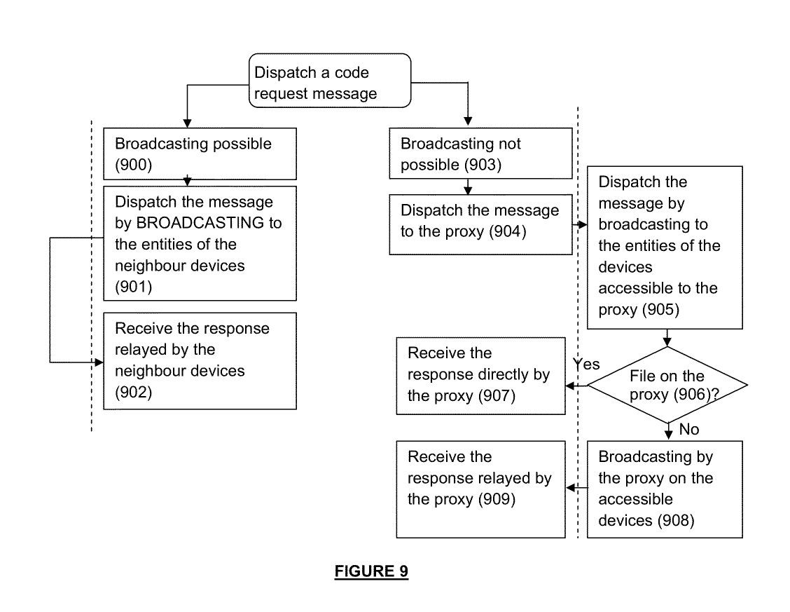

FIG. 9 is a flowchart illustrating the dispatching of a message requesting a component code from the supervision entity of a requesting device, in response to the creation or to the migration of a component, according to the broadcasting capabilities available.

If the requesting device A belongs to a communication network allowing simple broadcasting or multi-casting, the supervision entity dispatches its request by broadcasting (“broadcast” or “multicast”). The code request message is then received by the supervision entities of the devices customarily connected to this network (neighbour devices), which continue to relay it in the same manner if they do not have the code file sought. Each supervision entity which thus relays the message to other supervision entities can designate itself as possible relay for the return of the response to the supervision entity of the requesting device A.

The supervision entity on the requesting device A thus proceeds in accordance with the following steps, if the broadcasting of the messages (broadcast or multicast) between the mobile devices is possible (900):

A message requesting the code file associated with a component is dispatched by broadcast/multicast to the neighbour devices on all the accessible networks, the message indicating the type of the device A and the name of the class 606 sought (901).

The local supervision entities 6 of the neighbour devices 5 which receive the class search message process the message as explained in conjunction with FIG. 7: if the neighbour device which receives the message possesses this class, for example because it manages a repository of classes, or because it possesses an instance of this class, its supervision entity 6 dispatches the message to the requesting device A which then receives the code file from this entity (902); otherwise it relays in its turn the code request message to the devices which are accessible to it, in the same manner as the requesting device, while designating itself as possible relay to transmit the response to the requesting device which will then be able to receive the response via the supervision entity 6 of this neighbour device.

If the requesting device A does not allow message dispatch by broadcasting and depends on another communication network (for example GSM, 3G or 4G), the supervision entity 6 on the requesting device A can dispatch the message requesting the code of the component to a device serving as proxy 14. The proxy 14, associated with the supervision entity of the requesting device 10, may be a device comprising a supervision entity 6, having a public address on the Internet, and endowed with a broadcast/multicast dispatching capability. The device associated with the proxy may be of a type other than the requesting device which uses the proxy. For example, a device of PC type may be the proxy of a device of Android type. It may be previously associated with the supervision entity of the requesting device by the user by means of a man machine interface. The dispatching of messages by broadcast/multicast is then replaced with a dispatching live on the proxy associated with the requesting device A which will then relay the messages to the devices which are accessible to it, in accordance with the following steps:

the code request message associated with the component is dispatched to the proxy 14 (904) defined for the device A, the message indicating the type of the device A and the name of the class 606 sought.

the proxy 14 receives the code request message associated with the component (905): if it possesses the class sought (906), the supervision entity of the proxy dispatches the file to the requesting device (907); otherwise, the proxy 14 returns by broadcast/multicast the code request message associated with the component on all the networks which are accessible to it while designating itself as relay for the host sought (908).

the devices which receive a code request message associated with the component, relayed in the step, and which possess the classes associated with the component (for example, because they manage a repository of classes or because they possess an instance of this class) respond to the proxy 14 which will then be able to play the role of relay. The code file found will then be able to be relayed to the requesting device by the proxy (909); otherwise, these devices relay the message to the devices which are accessible to them, in the same manner as the requesting device, notably either by broadcasting or multicasting, if they have the capability therefor, or via a respective proxy 14 which is associated therewith.

This approach is similar to the class search approach by broadcasting of broadcast or multicast type, except that only the devices that can be reached by the proxy 14 are usable as providers of classes, such devices being able to dialogue only by way of this reference host.

In certain embodiments of the invention, the local supervision entity 6 on each electronic device is configurable by way of an interface so as to specify whether it may or may not use a broadcasting of broadcast/multicast type and, if appropriate, which proxy 14 it uses. Moreover, the management of the proxy to be used for the search for component classes, when the electronic device is not endowed with broadcasting or multicasting capability, can be integrated directly into the local supervision entity 6.

For the devices 5 having by nature a broadcasting/multicasting capability, message dispatch by broadcasting of broadcast/multicast type can be used by default for the class search. In certain embodiments of the invention, it may be possible to parametrize a supervision entity to force the dispatching of the code request messages by a proxy, for example when the network used does not allow broadcasting (broadcast/multicast).

As a variant, if the requesting device A is not associated with any proxy and does not have any broadcasting-based dispatching capability, the supervision entity of the requesting device can dispatch the code request message to all the devices that it knows to be its neighbours. Accordingly, the supervision entity can maintain the information relating to the supervision entities with which it has communicated in a DNS data structure (the acronym standing for “Domain Name Service”), stored locally. The DNS can comprise the names and addresses of all the devices with which the supervision entity has communicated. When a supervision entity starts, it can dispatch a starting message (for example “Hello”) to the supervision entities which are connected to the same network, so that any new supervision entity which enters a network is known and generates an entry on the DNSs of all the supervision entities customarily connected to this network.

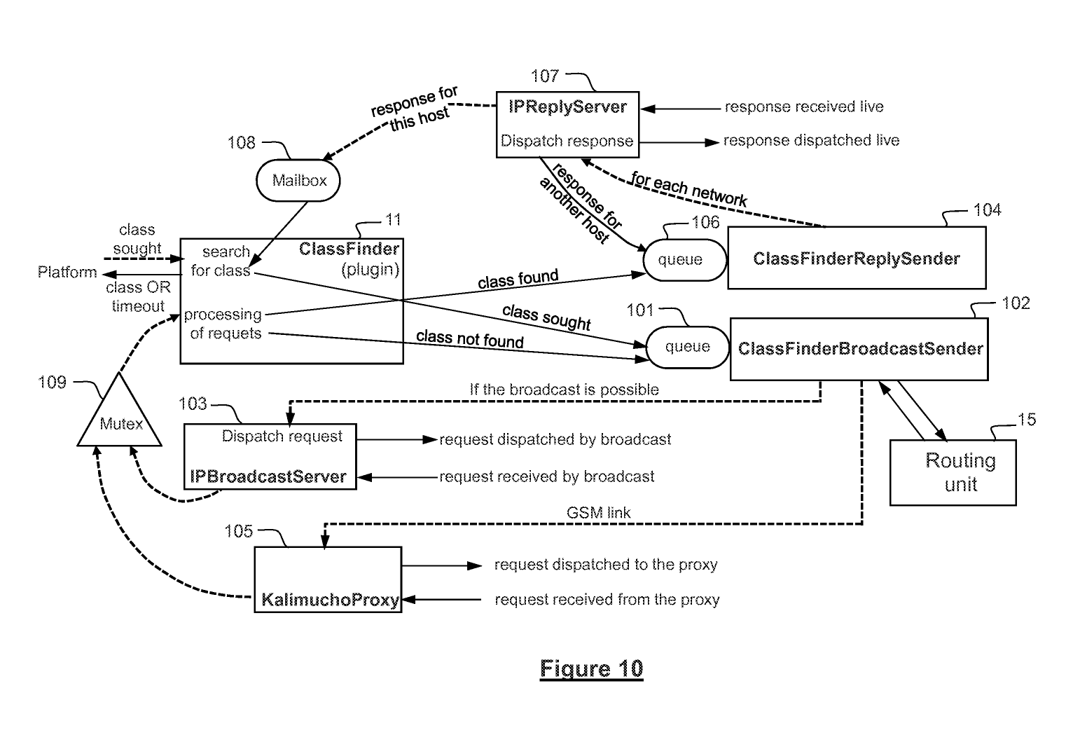

FIG. 10 illustrates the communication between the supervision entities for the dynamic loading of code, according to certain embodiments of the invention.

The local supervision entity 6 of each device 5 can communicate with the supervision entities on the other devices 5 not only to launch the code search for the creation or the migration of a component on the device 5 associated with the supervision entity (if the code is not locally available, the supervision entity then having a client role for the dispatching of messages requesting a component code to the neighbour devices), but also to perform a code search for a component created or migrated on another device, at the request of the supervision entity of this device (server role). It can also communicate with the supervision entities on other devices in the guise of simple relay so as to relay a code file to be forwarded to a requesting device.

As soon as non-resident code is necessary, subsequent to the creation of a component on a device or to the migration of a component on the device, the supervision entity 6 launches a code search with the code search unit 11 (also called “classfinder”) by indicating to it the code sought. The code sought can be identified by the name of the class of the component 302. The code search unit launches the code search by sending a code request message.

Each supervision entity 6 can comprise at least one queue 101 for storing the code request messages which must be dispatched to other devices. This queue 101 allows the code search entity to use the network in competition with other services of the supervision entity or the connectors 303. Upon the dispatching of a message by a local supervision entity 6, the message can thus be placed on standby in a queue until the network is available and/or until the message can actually be dispatched. From the point of view of the code search unit 11, the dispatching is considered to be done, but in fact the dispatching can be deferred.

Each supervision entity 6 can furthermore comprise at least one sender 102 (called in the figure “classFinderBroadcastSender”) for transmitting the code request messages placed in the queue 101 to a dispatching client 103 corresponding to the appropriate network as a function of the recipient of the message. In the preferred embodiment of the invention, when dispatch by broadcasting (broadcast or multicast) is possible, the local supervision entity 6 uses a message broadcasting (broadcast or multicast) based dispatching client 102, called, thereby making it possible to dispatch the message simultaneously to several neighbour devices. The sender 102 can dispatch the requests for codes of the queue 101 to the supervision entities 6 of the neighbour devices 5 by broadcasting via the broadcasting (broadcast or multicast) based dispatching client 103, called “IPBroadcastServer”. The broadcasting-based dispatching client 103 can furthermore receive the code requests received by broadcast/multicast broadcasting from the supervision entities 6 of other devices 5 and transmit them to the class search unit 11. In response to such requests, the class search unit 11 determines whether the code of components resides on the device 5, on the basis of a components code repository if the associated device manages such a repository or among the code files of components that it has received for the components that it hosts. If it finds the components code, it returns the code sought to a sender 104 intended to return the response to the relay device indicated in the request message so as to reforward it to the requesting device. Otherwise, if the code is not found locally (the device does not hold any component of the same class as the component which has been created on the remote device), it dispatches a message to the sender 102 (via the queue 101) so that the code request message that it has received is rebroadcast to the neighbour devices. If the broadcasting-based dispatching client 103 cannot reach the recipient identified in a message, it can notify same to the sender 102 which can call upon a routing unit 15. The routing unit 15 is configured to determine whether one or more other devices 5 in the route can serve as relays. When the routing unit 15 identifies such relay devices, the message is transmitted through these relay devices for transmission to the recipient.

Each supervision entity 6 operating on an electronic device 5 which has a public address can launch an additional proxy server 14. On a device 5 configured to access a network by satellite, the address of one of these proxies can be specified beforehand to the supervision entity of the device via an interface. The device 5 will then be able to establish a connection with this proxy that it will keep open so as to be able to receive messages and data. The device 5 can also launch a client 105 connected to this proxy 14 which will then be chosen by its messages sender 102 for all the messages dispatched by its local supervision entity 6, if a broadcasting of broadcast/multicast type is not possible, for example when the electronic devices are of 3G type.

The local supervision entity 6 can use the dispatching client connected to the proxy 105 to dispatch the code search messages to the directly reachable proxy 14 which was associated with it beforehand for the dispatching of code search requests sent by the class search unit 12. The proxy 14 defined for a given device can be another device 5 supported by the supervision system, reachable by the device 5 for example by GSM link, and which is endowed with a broadcast/multicast dispatching capability. The dispatching of messages by broadcast/multicast is then replaced with a live dispatching on the proxy 14 associated with the device A which will then relay the messages to the other mobile devices. Thus, for a component code search (search for class of the component), if broadcast/multicast broadcasting is not possible, the sender 102 dispatches the requests for codes of the queue 101 to the proxy client 14 which transmits them directly to the proxy 14 via the communication network supported. As soon as the proxy 14 has the component code file sought, either because it possesses it, or because it has been relayed to it by one of the devices to which it has dispatched the code request message by broadcasting, it returns it to the proxy client 105 which will transmit it to the code search unit 11.

As a supplement, to avoid the disconnections which may be caused by access providers, when establishing a connection with the proxy 14, the dispatching client 105 can dispatch, at regular intervals, a test message called “PING” (also designated by the acronym “Packet InterNet Groper”) intended to keep the connection with the proxy open. This exchange of test messages also allows the device 5 and the proxy 14 to detect losses of connection (due for example to mobility). Furthermore, listeners may be used (such as for example the broadcasting listener called “BroadcastReceiver” for devices of Android type) to allow the mobile devices 5 to toggle automatically from a mode of operation by proxy 14 to the normal mode of operation without proxy, upon a change of type of connection.

Each local supervision entity can furthermore comprise a mutual-exclusion semaphore 109, for example a mutex, for managing the competition between the messages dispatched to the code search unit 11. Indeed, the broadcasting-based dispatching client 103 and the Proxy client 105 have a similar role and can therefore both deposit a request with the search unit 12. The mutex 109 makes it possible to prevent these requests from entering into competition by processing the requests one after another.

To exchange with the other supervision entities messages of response to requests previously received or dispatched, the local supervision entity 6 uses the sender 104, called “classFinderReplySender”. The sender 104 manages notably the dispatching of responses to the code requests sent by other supervision entities. The role of the sender 104 is thus to dispatch the responses of the local supervision entity 6 via dispatching clients 107, according to the various types of accessible networks, to supervision entities on other devices. The search unit 12 places the responses in a queue 106 so that they are processed one after another by the dispatching clients 107. For example, when the device 5 has a WIFI capability, it can pass through the dispatching client 107 of WIFI type, called “IPReplyServer”, represented in FIG. 10. As a variant, if the device has other means of communication, for example Bluetooth, the messages of the queue 106 can be processed by another suitable dispatching client 107 (for example, Bluetooth dispatching client). In FIG. 10, a single dispatching client is represented by way of illustration. However, the person skilled in the art will understand that the invention is not limited to this type of response dispatching client and that the supervision entity can include other types of dispatching clients as a function of the networks available.

The dispatching client 107 can furthermore receive code files transmitted by supervision entities 6 on other devices 5, in response to a request sent by a requesting device. In this case, the supervision entity 6 simply serves as relay to transmit the code files received to other devices destined for the requesting device (role of relay for code file return), the dispatching client 107 returns the code files to the final recipient of the message by using whichever means of communication it has (WIFI in the example). Otherwise, if the device is the recipient of the code file, the dispatching client 107 deposits the code file in a mailbox 108.

The dispatching client 107 is also configured to dispatch code files found locally by the search unit 12 to another device 5, identified as relay, which will make it follow in the same manner until the supervision entity of the requesting device A, in response to a component code request (for example by WIFI in the embodiment of FIG. 10). Such a situation can notably occur when the device 5 associated with the dispatching client 105 hosts a component 302 of the same class as the one requested, or manages a components code repository 60.

The mailbox 108 is used to store the responses of the search unit 12. It should be noted that the supervision entity 6 can execute reconfiguration commands in parallel so that several code requests can be dispatched at the same time. The responses might not return in the order of the requests. Hence the mailbox 108 makes it possible to place them on standby waiting to be processed.

The queues 101 and 106 allow other services of the supervision entity and the connectors 303 to use the network in competition. Therefore, upon the dispatching of a message, the message is placed on standby in a queue until the network is available and until it can be dispatched. From the point of view of the service of the supervision entity or of the connector, the dispatching is considered to be done, but it may be deferred. In the queues 101 and 106, the requests can be associated with priority rules which will be taken into account in respect of the order of dispatching of the requests.

The unit for searching for routes 15 allows the supervision system 10 to support any type of communication network between the mobile devices 5. In particular, it makes it possible to relay the class search messages when two devices 5 depending on different communication networks cannot establish any direct communication between themselves. This makes it possible notably to establish at any moment a connection between two local supervision entities 6.

The unit for searching for routes 15 is interrogated by the sender 102 of the supervision entity 6 to determine one or more relays for a communication with the supervision entity hosted on another device, when necessary. It can also be interrogated to determine the device which is to receive a relay connector when two components must be linked although they do not have any possibility of a direct linkage.

In one embodiment of the invention, the unit for searching for routes 15 uses a mechanism of “PING” type and broadcast, multicast, or point-to-point messages to the neighbouring hosts. Thus if a device A searches for a route to reach a device B, the mechanism is as follows: the device A attempts firstly to reach the device B directly by dispatching a PING message type. If the device B responds to the PING message, the link is direct and the route search is terminated. In the converse case, the device A dispatches to all its neighbours (reached by dispatching by broadcasting/multicasting) a search message in respect of the device B. Each of its neighbours then attempts to reach the device B through a PING message. The devices which succeed in reaching the device B indicate to the device A that they can serve as relay for the device B. Those which do not succeed therein broadcast this request in their turn to their own neighbours. The device A may receive several responses. In this case, it can choose as route that which corresponds to the first response received and which represents the fastest route.

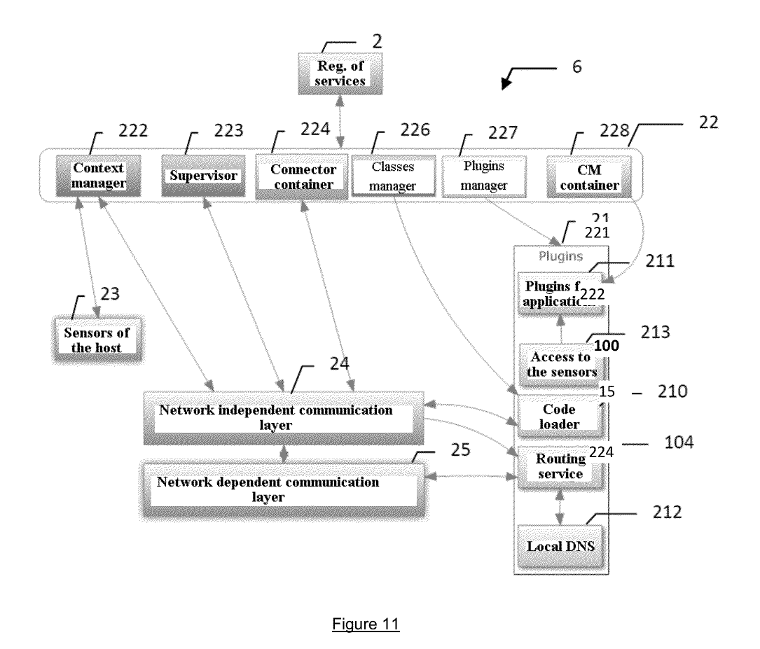

FIG. 11 shows an exemplary kernel architecture for each local supervision entity 6 for the control of inter-component communication. Each local supervision entity 6 can comprise:

a registry of services 2 which allows the local supervision entity 6 to access a set of services offered by the supervision system 10;

a network independent communication layer 24 and a network dependent communication layer 25: these layers allow the local supervision entities 6 hosted on respective mobile devices to communicate with one another and serve as support to the connectors between components; the network independent communication layer 24 provides mechanisms (queues, semaphores, etc) which can be used by the supervision entity and the connectors to dispatch and receive objects and the network dependent communication layer 25 provides notably mechanisms for implementing the network communications for the supervision entity and for the connectors.

The local supervision entity 6 can furthermore comprise the following elements 22 used for the supervision of the applications:

a supervision module 223 (also called a “supervisor”) to execute the commands for deployment or reconfiguration by controlling execution of commands for component creation, deletion, migration, connection, deconnection and/or execution of commands for connector creation, deletion, duplication, redirection;

a context manager 222 to control the context of the applications, notably on the basis of sensors of the device 23; it receives notably information on the state of the application currently executing, in particular information relating to the components, to the connectors linking the components and to the host devices 5;

containers 224 of connectors 303;

a component classes manager 226 for dynamically managing the loaded classes; it furthermore creates class loaders 12 for each code file downloaded for a new component received on the host.

the containers 305 of components 302; and

a module manager 227 which may be extension modules (or plugins) for controlling a modules set 21. The modules manager 227 is adapted for launching or stopping modules 21 of the supervision entity. It can use a description file which indicates the plugins which are automatically executed when the supervision entity stops. Modules 21 can be added or deleted during execution.

The modules 21 can furthermore comprise:

a module for applications (also called “plugins for application”) 221 which allows the components to access resources managed by the supervision entity 6. These resources can comprise conventional resources (for example, texts, images, etc.) or else hardware specific resources (such as sensors 222, a GPS system (the acronym standing for “Global Positioning System”), or else an SMS system (the acronym standing for Short Messaging System”, etc.); this unit allows notably the components to dispatch commands to the local or remote supervision entities and to receive responses.

The code loading function 100 for loading the code associated with a component received on the host device 5; it interacts notably with the class manager 226.

The routing unit 15 for the calculation of routes (also called routing service); and

a local DNS 224 (DNS is the acronym standing for “Domain Name System”).

The registry of services 2 can operate in a manner similar to the JAVA application called “RMI registry” but in local mode, that is to say referring solely to the services hosted on the supervision entity 6 local to the electronic device 5. The services of the local supervision entity 6 are registered therein. For example, during the creation of a distributed connector, commands are dispatched to the other local supervision entities 6 while interrogating the registry of services 2 so as to obtain the service responsible for the network-based communication layers 24 and 25. In the same manner, each connector 303 container 224 can be registered as a service which will be able to be used by the local supervision entity 6 to control it and allow its dynamic discovery by the component 302 containers 305 to establish their connection to the input or output streams. Moreover, each container 305 of a component 302 can register its control unit 40 as a service allowing the local supervision entity to control the various phases of the life cycle of a component.

The components 302 can access the services of the supervision system 302 by way of the registry of services 2, notably the services 221. The other services are accessible by the local supervision entity 6.

The supervision module 223 receives and executes commands originating from the other local supervision entities 6 hosted on the other mobile devices 5, from the components 302 or from a decision module.

These commands can include commands relating to the components 302 that may comprise commands to create, delete, migrate, connect, disconnect and duplicate the output streams of the components. These commands can comprise:

A component create command taking as parameters an input and outputs list that may be empty or marked to be used subsequently;

A command to delete a given component;

A command to dispatch a component to a destination;

A command to disconnect an input of a component;

A command to disconnect an output of a component;

A command to reconnect an input of a component; and

A command to duplicate an output of a component.

The commands can furthermore include commands relating to connectors 303, such as commands to create a connector, to delete connectors and to redirect connectors. The commands can also comprise commands relating to context making it possible to recover the states of the host 5, of the containers 224 of connectors 303, of the containers 305 of components, and of the quality of service indicated by a component. Such commands relating to context include:

a command which returns an object containing the context of a host, that is to say the memory occupancy, the state of the battery, the CPU load, the mean network bitrate at input and at output over the last second.

a command which returns an object containing the context of a container. If the name designates a component container 303, this command returns the names of the linked connectors at input and at output. If the name designates a connector container 303, this command returns the addresses of the hosts hosting the input and the output of this connector.

a command which returns an object containing the Quality of Service of a container. If the name designates a component container 302, this command returns the value indicated by the component. If the name designates a connector container 303, this command returns the degree of fill of the inputs and output buffers of the connector 303 as well as the mean bitrate since creation.

The local supervision entities 6 can execute a set of methods which must be overloaded, for example:

A method which returns the quality of service (QoS) offered by the component 302,

The method called “run_BC( )” which is executed to toggle a component 302 to the active state 52 (FIG. 5). In certain embodiments of the invention, the “Run_BC” method never terminates (data stream) and accordingly comprises a loop of the “while” type (while(is Running( ) in programming language). If a component 302 wishes to stop its execution, in such a way that the local entity 6 can migrate it or stop it, a method called “idle( )” can be called.

The local supervision entities 6 can furthermore execute methods that may be overloaded, notably:

The initialization method called “init( )”, for initializing a component 302. The initializations of the properties of a component 302 can be done in the “init” method or at the start of the “run_BC” method (before the loop). The “init” initialization method is executed during the first launch of the business component 302. However, it is not restarted after a migration. The initializations done in the “init” method consequently relate to the properties which will be serialized during a migration. Thus, the creation of an interface, the access to local devices or the putting in place of events listeners on certain input streams can be done at the start of the “run_BC” method so as to be taken into account during a migration.

The destruction method called “destroy( )” which is executed upon the definitive stopping of the component and also before a migration.

The following methods are inherited from the class of the models of components, called “BCModel”, and may be usable by each component 302. They comprise methods relating to the state of the component 302 including:

a component stopping method called “idle( )” which stops the component but does not delete it;

a method which indicates whether the component 302 can continue to execute, called “is Running( )” and of boolean type. In the case where the component must be stopped, this method can lift the class exception called “StopBCException”.
a method indicating the state of migration of the component 302, of boolean type. This method can for example return the value “TRUE” if the component 302 has been migrated.

The “idle( )” and “is Running( )” methods are preferably disabling: if they are called by another execution thread, they do not execute and display an error.

The methods inherited from the “BCModel” components models class and usable by each component 302 can also comprise methods relating to the environment of the component such as:

A method which returns the name of the component;

A method which returns the number of inputs of the component 302;

A method which returns the number of currently connected inputs of the Component 302;

An input connection indication method to indicate whether the input designated by the parameter is currently connected to a connector;

A method which returns the number of outputs of the component 302;

A method which returns the number of currently connected outputs of the component 302;

An output connection indication method to indicate whether the output designated by the parameter is currently connected to at least one connector.

The methods inherited from the “BCModel” components models class and usable by each component 302 can also comprise Methods relating to the inputs such as:

A method for creating a filter of data of a specified class, on an input of the component 302;

A method for deleting the filter of data on an input of the component 302 which receives an input number as parameter;

A method for reading the data on an input of the component;

A method for reading the data of a class on an input of the component;

A method for reading the first data available on the inputs of the component 302;

A method which indicates the availability of data on an input of the component 302;

A method for adding an listener as input of a component 302;

A method for deleting listeners.

Other methods usable by the components can relate to the outputs of the components 302 and comprise a method for writing on an output of the component 302.

Other methods that can be called by the components may relate to events (input listeners or interfaces), such as a standby method for awaiting a component event or a method for dispatching an event to the component.

The components 302 can also call methods relating to the resources contained in the code file associated with the component (jar file). The resources can be placed in a sub-directory of the directory containing the component. The component 302 can access it by using methods called “getResourceAsByteArray” (recovery of the resource in binary form) or “getResourceAsStream” (recovery of a reading stream for the resource).

According to another characteristic of the invention, each local supervision entity 6 can maintain information relating to all the local supervision entities 6 with which it has entered into communication. In particular, this information can be registered in the local DNS 224. For each other local supervision entity 6 identified by the DNS 224, the DNS 224224 can store the following information:

a unique identifier associated with the local supervision entity 6;

The list of the known addresses of this local supervision entity 6 on each of the networks which it accesses;

The clock Shift with this local supervision entity 6 and the maximum error of measurement of this shift.

During each message receipt (for example, class search message) by the local supervision local entity 6 originating from a local supervision entity 6 hosted on another device, the DNS 224 registers the sending supervision entity 6 and its address. During exchanges of messages of PING or route search type, on receipt of the response, the DNS 224 calculates the shift of clocks (these messages contain the send time extracted from the local clock of the sending supervision entity 6). The time of exchange of these messages furthermore makes it possible to determine a maximum error bound on the measurement of this shift.

Each indirect route found causes the addition of the supervision entity 6 serving as relay and of that at which the route culminates.

Moreover, at regular intervals, the supervision entities 6 can exchange the contents of their DNSs 224. The information thus received can be used to update each local DNS, notably to add supervision entities 6 which were not registered therein, or to supplement the lists of addresses of the supervision entities 6.

The clock shifts received make it possible to calculate new values, for example:

Shift between host A and host B=shift between A and C+shift between C and B, and

Error in the shift between host A and host B=Error in the shift between A and C+Error in the shift between C and B.

These values can thus supplement the local DNS 224 or replace the local values when the calculated error is less than that customarily known locally.

The clock shifts of the DNS can be used for the management of the connections, notably to date the objects exchanged in local time. Indeed, the dispatched data are automatically dated upon their creation and this date is adjusted by the connectors 303 upon receipt. When the clock shift with the sender host is not known, the connector 303 dates the data item by the local time of its receipt.

To take account of the mobility of the devices 5, the registrations of the DNS 224 preferably have a limited lifetime and are deleted at their term. A maximum value can be assigned to this lifetime during each successful communication, and then readjusted on the basis of the lifetimes of the DNSs received from the other supervision entities 6 (the maximum value can then be retained). Thus a supervision entity 6 which disappears or loses all connection will be able to be deleted from all the DNSs. Likewise, a supervision entity 6 which does not communicate with any other supervision entity (for example, no message has been exchanged with other supervision entities) will be able to be deleted from all the DNSs, and reappear in the DNSs as soon as the corresponding supervision entity communicates again with other supervision entities.

The inventors have performed a certain number of measurements relating to the supervision system 10, in particular on the complexity, the time to execute the commands, the times to transfer information in the connectors and the time to deploy an application.

Most of the executions of commands supported by the supervision system induce short standby times (response by network of another supervision entity, route search etc.). A reconfiguration generally consists of several commands (addition/deletion of components and/or of connectors for example). These standby times are optimized by the supervision system 10 by allowing the parallel execution of these commands. Hence, the time to execute a reconfiguration is less than the sum of the times to execute each of the commands taken independently.

In accordance with the measurements performed, the reconfiguration times are sufficiently short to allow the supervision system to rapidly adapt an application to a change of context. The scaling (bigger number of devices involved in the reconfiguration) does not modify the situation significantly since each supervision entity on a device can execute its commands in parallel with the others.

The supervision system 10 according to the invention thus makes it possible to execute applications (i.e. components forming all or part of an application) on various devices 5 that may be mobile and to act warm on the architecture of the application when necessary.

The invention is not limited to the embodiments described hereinabove by way of non limiting example. It encompasses all the variant embodiments that may be envisaged by the person skilled in the art. In particular, the invention is not limited to the supervision entities architecture represented in FIG. 11. Neither is it limited to the particular structure of code repository of FIG. 6, or to a particular structure of code file. For example, the code files may be enciphered for greater security. Moreover, the supervision entities can be parametrized in various ways, by the user. Thus, the supervision entities may use an identifying list of the components refused by the user. Such a list can be parametrized by the user through a configuration interface for the supervision entity, so as to designate components which must not be installed on the device (for example a component that has to use a GPS location system will not be installed by the supervision entity if the user has specified that he refused to be located). The supervision entities can furthermore be configured to manage the purchase of components.

The person skilled in the art will understand that the supervision entities 6 according to the embodiments of the invention can be implemented in diverse ways by hardware, software, or a combination of hardware and software.

In particular, the elements of each supervision entity can be combined or separated into sub-elements to implement the invention. Furthermore, they can be implemented in the form of computer programs executed by a processor. A computer program is a set of instructions which can be used, directly or indirectly, by a computer.

A computer program can be written in any programming language, including the compiled or interpreted languages, and it can be deployed in any form whatsoever in the chosen computing environment.

1. A system for supervising applications executing on a set of electronic devices connected together by one or more networks, wherein each device comprises a local supervision entity, the supervision entities cooperating together to control the applications executing on the electronic devices, each application comprising a set of application components, and the supervision entity of a given device is able to execute the following steps, in response to a command to receive an application component on said device, being a receiver device, said component having a given starting state:
communicating with a set of supervision entities to search for a code file comprising the executable code associated with the application component,
loading the executable code file associated with the component on said reception device, in response to the availability of the code file on the reception device,
starting the component in said starting state on the basis of the loaded code, by encapsulating it in a container controllable by the supervision entity.

2. The supervision system according to claim 1, wherein said reception command is a command to create the component on the device, and said starting state is an initial state.

3. The supervision system according to claim 1, wherein said reception command is a command to migrate the component on the reception device from a source device, and said starting state is the state of the component in said source device.

4. The supervision system according to claim 1, wherein the code file search comprises the dispatching of a code request message by the supervision entity of the reception device to the supervision entities of said set of supervision entities, said message comprising information relating to the component and to the reception device.

5. The supervision system according to claim 4, wherein said code request message is relayed by each supervision entity receiving the message to another set of supervision entities, if the device hosting the receiving supervision entity does not hold the code file associated with the component.

6. The supervision system according to claim 5, wherein the step consisting in relaying the code request message to another set of supervision entities comprises the designation of the receiving supervision entity as relay for the dispatching of a response comprising the code file from another supervision entity to the reception device in the relayed message.

7. The supervision system according to claim 1, wherein each supervision entity receiving the code request message is able to search for whether the device hosting the supervision entity holds a code file associated with the component on the basis of the name of the class of the component.

8. The supervision system according to claim 1, wherein each supervision entity receiving the code request message is able to determine whether the device hosting the receiving supervision entity holds a code file associated with the component by performing a search in a components code repository, on the basis of the information relating to the component and to the reception device, if the device hosting the receiving supervision entity manages a components code repository storing code files to components.

9. The supervision system according to claim 1, wherein the supervision entity of the reception device is able to dispatch said code request message by broadcasting the message, if the device has a broadcasting-based dispatching capability, said set of supervision entities comprising the supervision entities of the neighbour devices receiving said message dispatched by broadcasting.

10. The supervision system according to claim 1, wherein the supervision entity of the reception device maintains information relating to the supervision entities with which it communicates in a data structure and the supervision entity of the reception device is able to dispatch said code request message to supervision entities that are determined on the basis of said data structure.

11. The supervision system according to claim 1, wherein the supervision entity of the reception device is able to dispatch said code request message to a predefined proxy able to relay said message by broadcasting, said set of supervision entities comprising supervision entities of the neighbour devices receiving said message dispatched by broadcasting by the proxy.

12. The supervision system according to claim 11, wherein the proxy is a supervision entity on a device having a public address on the Internet.

13. The supervision system according to claim 1, wherein each supervision entity comprises a sender configured to transmit the requests for code associated with a component to a broadcasting-based dispatching client, said broadcasting-based dispatching client being configured to dispatch the messages of requests for code associated with a component to the set of supervision entities.

14. The supervision system according to claim 12, wherein the sender is configured to transmit the code requests associated with a component to a client connected to the proxy.

15. The supervision system according to claim 14, wherein the connection with the proxy is kept open to allow the receipt of the responses relayed by the proxy in response to the code request.

16. The supervision system according to claim 15, wherein the connection is kept open by using the dispatching of messages of PING type.

17. The supervision system, according to claim 1, wherein each supervision entity comprises a response sender for dispatching the response of the supervision entity to a code request message to the supervision entity of the device which has relayed thereto the code request message originating from the reception device, the sender being configured to transmit the response to said supervision entity via at least one specific dispatching client according to the network available.

18. The supervision system according to claim 3, wherein each component is associated with a given class of component, and the information relating to the component comprises the name of the class of the component.

19. The supervision system according to claim 3, wherein the information relating to the component comprises the type of device.

20. The supervision system according to claim 1, wherein the local supervision entity of the reception device is able to load the code file by using a code loader associated with the code file.

21. The supervision system according to claim 1, wherein the code loader associated with the code file on the device is created during the first creation of the component on the reception device.

22. The supervision system according to claim 21, wherein the linkage between the component and its code loader is stored in the container of the component.

23. A process for supervising applications executing on a set of electronic devices linked together by one or more networks, each application comprising a set of application components, wherein said process comprises the following steps, in response to a command to receive an application component on a device, being a reception device, said component having a given starting state:
searching for a code file comprising the executable code associated with the application component on a set of devices;
loading the code file associated with the component on said reception device, in response to the availability of the code file on the reception device,
starting the component in said starting state on the basis of the loaded code, by encapsulating it in a locally controllable container.
